(19) United States
(12) Patent Application Publication
(10) Pub. No.: US 2008/0311298 A1
(43) Pub. Date: Dec. 18, 2008

(54) Device, System and Method for Treating the Surfaces of Substrates

(75) Inventor: Heinz Kappler, Dornstetten-Aach (DE)

Correspondence Address: AKERMAN SENTERFITT, P.O. BOX 3188, WEST PALM BEACH, FL, 33402-3188, US

(73) Assignee: Gebr. Schmid GmbH & Co., Freudenstadt (DE)

(21) Appl. No.: 12/139,317

(22) Filed: Jun. 13, 2008

Related U.S. Application Data
(63) Continuation of application No. PCT/EP2006/012116, filed on Dec. 15, 2006.

(30) Foreign Application Priority Data
Dec. 16, 2005 (DE) 10 2005 062 528.2

(51) Int. Cl. B05D 5/00; B05C 13/00

(52) U.S. Cl. 427/256; 118/500

(57) ABSTRACT

The invention relates to a device for treating the surfaces of silicon wafers, comprising transport rollers for transporting the silicon wafers on a transport plane, which is determined by the transport rollers, and at least one conveyor device which wets the silicon wafer with an aqueous process medium. The conveyor device is arranged in such a manner below the transport plane that it touches the transport plane for wetting the substrate surface, which is oriented in the downward direction, with a process medium. The conveyor device is in direct contact with the substrate surface and is a roller with a larger diameter at its two ends for contacting the marginal areas at the underside of the silicon wafers for wetting them with the process medium.

### FIELD OF APPLICATION AND PRIOR ART

The invention relates to a device and to a system with such devices for the surface treatment of substrates, with transport means for transporting a substrate in a transport plane defined by the transport means and with at least one conveying means constructed for the wetting of the substrate with a liquid process medium. The invention also relates to a method for wetting a downwardly directed substrate surface with a process medium, advantageously in direct or mechanical contact.

DE 102 25 848 A1 discloses a device used for the removal of a coating from a top surface of a flat substrate. A solvent is then sprayed by nozzles inclined from above onto the substrates. The substrates are located on transport shafts and are transported by the latter. At least a lateral end of the substrates projects above the transport shafts, so that the solvent flowing off the substrate and which contains the detached coating constituents as a result of the projecting length of the substrates flows past the transport means. This is intended to prevent a contamination of the transport means. The coating removal using the solvent serves to remove photoactive coatings prior to an etching process to ensure that only exposed and developed surface areas of the substrates are provided with a protective coating effective for the etching process. Thus, the coatings have already been structured as a result of the exposure and development of the photoactive coatings.

In other surface treatment processes, particularly for coating removal and which are carried out on substrates, for example on silicon disks or plates, known as wafers and used more specifically for the production of semiconductor components and solar cells, there can be a wetting of individual substrate surfaces with the process medium. Wetting is to take place in such a way that the remaining substrate surfaces which are not to have a protective coating in the aforementioned sense or some other coating, are not attacked by the process medium to be applied, so that a coating removal only takes place on the substrate surface wetted with the process medium. This is not ensured when using the known device.

### PROBLEM AND SOLUTION

The problem of the invention is to provide a device, a system and a method permitting a selective surface treatment of substrates.

According to a first aspect of the invention this problem is solved by a device having the features of claim 1, in which the conveying means are positioned below the transport plane in such a way that it contacts or extends at least virtually to the transport plane in order to permit a wetting of the downwardly directed substrate surface with process medium in direct contact between the conveying means and the substrate surface. Advantageous and preferred developments of the invention form the subject matter of the further claims and are explained in greater detail hereinafter. The device, system and method are in part jointly explained and these explanations and the corresponding features apply both to the device and the method. By express reference the wording of the claims is made into part of the content of the description.

The downwardly directed substrate surface is substantially planar and is oriented in such a way that a surface normal on said substrate surface runs at least substantially perpendicular in the vertical downwards direction. The downwardly directed substrate surface is located in the transport plane defined by the transport means and constitutes the surface to be wetted with process medium. Further downwardly directed substrate surfaces not located in the transport plane are not to be wetted with the process medium.

The transport plane is the particular plane in which a substrate to be transported contacts the transport means and is substantially horizontally oriented or assumes an acute angle to the horizontal. As a function of the arrangement of the transport means, the transport plane can be a curved transport surface and then there is an at least substantially horizontal orientation of transport surface portions.

To ensure a selective wetting of the downwardly directed substrate surface with the process medium, there is a direct contact between the conveyor and the downwardly directed substrate surface. Thus, a liquid film of the process medium adhering to an outer surface of the conveyor is transferred to the downwardly directed substrate surface to be wetted without there being an undesired or uncontrollable spreading of liquid, gaseous or spray-like process medium. Instead the liquid film is rolled or stripped on the substrate surface, so that there is only a very limited spreading of the process medium. As a result substrate surfaces on which no wetting takes place are not undesirably subject to process medium application. This ensures a high selectivity of the wetting process and the working process brought about by the process medium.

In a development of the invention with the conveying means is associated a supply device for supplying process medium to an outer surface of the conveying means. A supply device can be constructed as a spray nozzle, which for example sprays through a spraying slit an area of the outer surface of the conveying means and which as a result of a movement of the latter can be brought into mechanical contact with the substrate surface. In a preferred embodiment of the invention the supply device is in the form of a tank for receiving the liquid process medium and the conveying means can periodically and preferably continuously, especially zonally be moved below a liquid level of the process medium, so that the latter can be transferred to the outer surface of the conveying means from where there is a transfer to the downwardly directed substrate surface.

In a further development of the invention the conveying means has a porous outer surface, which is in particular constructed for the transport of process medium from at least one delivery point provided in the conveying means to the outer surface of the latter, preferably by the introduction of pressurized process medium into the conveying means. A porous surface, which can be implemented as a coating of the conveying means with an open-pored, foamed or expanded plastic matrix or as a sintered coating formed by the pressure sintering of metal particles, reliably ensures the transfer of a process medium adhering to the surface of the conveying means. The process medium can be held in pores of the porous outer surface of the conveying means by surface tension and is transferred by the mechanical contact between the outer surface of the conveying means and the substrate surface in an at least partial manner to said substrate surface. The pores also constitutes reservoir for the process medium, so that a capillary gap occurring between the conveying means and the substrate surface ensures an advantageous distribution of the process medium.

In the case of a foamed, open-pores coating in the manner of an in particular elastically deformable foam, an influencing of the pore size and pore distribution is possible through the choice of appropriate polymer materials. With a sintered coating the pore size can be defined by the selection of a suitable size of metal particles used for the sintering process.

In a preferred embodiment of the invention process medium is supplied through a delivery point in the conveying means to the porous outer surface applied to the same. Such a process medium supply can in particular take place with supply channels located in the conveying means and with pressurized process medium introduced into the supply channels. The supply channels are so located in the conveying means that they terminate in the vicinity of the porous outer surface and consequently ensure a transport of the liquid process medium to said outer surface. With such a process medium supply there is a possibility of ensuring a particularly limited atomization of the process medium, because there is only a relative movement in the sense: of a rolling or stripping movement between the outer surface and the substrate surface. However, a relative movement between the conveying means and a tank filled with the process medium or a spraying process for the process medium is unnecessary. Thus, it is possible to implement a particularly selective application of the process medium to the substrate surface.

According to another development of the invention, the conveying means has an outer surface with a plurality of through holes, which are preferably connected to supply channels for supplying with process medium from a delivery point in the conveying means. The through holes can be introduced in a closed, metal or plastic outer surface of the conveying means using conventional cutting or material-removing methods, particularly laser drilling. The through holes are linked with the supply channels permitting a supply of the outer surface with process medium via a delivery point located in the conveying means. This particularly brings about a targeted delivery of process medium to the substrate surface. In an embodiment of the invention the supply channels are coupled with the delivery point, for example a pressure line for the process medium, in such a way that in each case one or a few of the supply channels are simultaneously connected to the pressure line, so that at a single point in time only one area of the outer surface of the conveying means is supplied with process medium. This ensures that process medium is supplied via the through holes to only that area of the outer surface which comes directly into contact with the substrate surface.

In a further development of the invention the conveying means is constructed as a conveyor roller, which is arranged in such a way that it touches the transport plane. A conveyor roller has a substantially cylindrical design and is mounted in rotary manner on the device. A median longitudinal axis of the conveyor roller is oriented parallel to the transport plane and is roughly spaced from the transport plane by an amount corresponding to the conveyor roller radius. Thus, the conveyor roller tangentially touches the transport plane and permits a linear contact of the substrate surface. As a result of the rotary mounting of the conveyor roller, it is possible for there to be a unidirectional identical surface speed of the outer surface of the conveyor roller and the substrate surface in the transport plane, so that it is possible to implement a substantially friction-free and at least approximately slip-free wetting process through the rolling -of the outer surface on the substrate surface. This ensures a wetting process for the substrate surface where only limited process medium atomization occurs. Through the design of the conveyor as a conveyor roller it is possible to apply the extremely thin process liquid coating flat to the substrate surface, so that with very thin substrates it is virtually impossible for there to be a passage of process medium to other substrate surfaces which are not to be wetted.

According to a further development of the invention the conveyor roller is provided with circumferentially directed grooves. This in simple manner implements a profiling of the outer surface of the conveyor roller and the circumferentially directed grooves ensure an improved process medium adhesion. In the case of the linear contact between conveyor roller and substrate surface the grooves running orthogonally to the contact line ensure a flat supply with process medium. A groove depth in the range 0.1 mm to 1 mm, preferably 0.2 mm to 0.8 mm can be provided and said grooves can have a uniform depth or different groove depths.

According to a further development of the invention, the conveyor roller is provided with axially directed grooves. This is of particular interest if the conveyor roller is immersed into a tank partly filled with process medium and where the process medium is conveyed out of the tank by a rotary movement. The axially directed grooves ensure that the process medium during the rotary movement of the conveyor roller cannot completely run off the outer surface of the latter, thereby ensuring an adequate process medium supply.

According to a further development, the conveyor roller is provided on an outer surface with a plurality of depressions, particularly holes. The depressions, which can be made by cutting or material-removing, particularly laser optical or chemical processes in a solid outer surface of the conveyor roller, in much the same way as the pores permit an advantageous process medium adhesion to the outer surface and consequently ensure that the substrate surface is supplied with process medium. The depressions can have a regular or irregular contour and can range between a macroscopic size in the range 1/10 mm and a microscopic size in the range of a few 1/1000 mm with regards to extension and depth.

In a further development of the invention, the conveyor roller is so fitted to a tank that can be filled with process medium that an outer surface of the conveyor roller can be wetted with process medium by an in particular permanent immersion in said medium. This ensures a particularly simple and reliable process medium supply to the conveyor roller. The conveyor roller is so fitted to the process medium-filled tank, that it at least touches a process medium level. Preferably the conveyor roller is immersed in the process medium and is given a rotary movement by a drive mechanism or the substrate, so that there is a permanent circulation of the conveyor roller in the process medium and the conveyor roller is also permanently wetted with the process medium. Through conveyor roller rotation circumferential portions of the outer surface of the conveyor roller freshly wetted with process medium come into contact with the substrate surface, so that there can be a continuous, flat or a real wetting of the substrate surface moved in the transport plane.

In another development of the invention, the conveyor roller is immersed at least by one third of the diameter or up to a median longitudinal axis in the process medium. This ensures a particularly advantageous wetting of the conveyor roller outer surface. Thus, the conveyor roller only requires a rotation by an angle of less than 90° in order to convey process medium from the tank to the downwardly directed substrate surface.

According to a further development of the invention, the conveyor roller is coupled to a drive mechanism for the transfer of a rotary movement and is constructed as a transport means for the substrate, preferably the sole transport means. Apart from conveying process medium to the substrate surface, the conveyor roller is also used for a substrate transporting movement and therefore fulfils a double function. This permits a particularly simple and compact design of the surface treatment device.

In another development of the invention, the conveyor rollers have a varying diameter with at least two larger diameter areas and at least one smaller diameter area. Preferably in each case on the sides of the conveyor rollers there are two larger diameter areas with the other area between them. The larger diameter areas can project over the smaller diameter area by approximately 1 mm to 10 mm, preferably 2 mm to 5 mm. The larger diameter areas are advantageously significantly narrower than the other area and can for example be at least 10 mm, preferably 12 mm to 30 mm wide.

As described, the larger diameter areas can be constructed for liquid transfer to the underside of the substrates. A smaller diameter area can have a smooth and/or closed surface.

In a further development of the invention, several conveyor rollers are successively located in the conveying direction. This ensures a reliable substrate surface wetting, because all the successive conveyor rollers are immersed in the process medium-filled tank and therefore there can be a multiple transfer of process medium to the substrate surface.

In a further development of the invention a process medium is provided, which is in particular an aqueous solution with at least one of the substances hydrofluoric acid (HF), hydrochloric acid (HCl), nitric acid (HNO₃) or potassium hydroxide (NaOH). Thus, electrically conductive coatings typically applied in the manufacture of semiconductor components or solar cells can be removed from the substrate surface in order to prevent an electrical connection of active substrate areas via the downwardly directed substrate surface.

According to another development of the invention, at least one suction means is provided for the sucking off of gaseous and/or mist-like distributed process medium from the environment of the conveying means, the at least one suction means being positioned vertically below the transport plane. On wetting the downwardly directed substrate surface, vaporized and/or atomized process medium can occur in the vicinity of the conveyor and can be deposited in an undesired manner on other, non-downwardly directed substrate surfaces. To prevent damage to such possibly unprotected surfaces by the process medium, suction means are provided which suck off the process medium in vapour and/or mist form from the conveyor environment and thereby prevent deposition on other substrate surfaces. The at least suction means is positioned below the transport plane in order to be able to bring about a substantially vertically downwardly directed air flow and in this way prevent an upward rise of vapour and/or mist-like process medium above the transport plane.

Typical process media, such as aqueous solutions of hydrofluoric acid, nitric acid, hydrochloric acid or potassium hydroxide form gases or mists, which are heavier than air and which can rise above the transport plane as a result of the relative movements between the transport means, conveying means and substrates. The suction means is based on the use of a vacuum, which is preferably chosen in such a way compared with a normal pressure in the conveyor environment that it is possible to build up a virtually turbulence-free, particular laminar flow in the vertical downwards direction.

According to a second aspect the problem of the invention is solved by a system having the features of claims 9 or 10. According to the invention the system has at least two above-described devices, the substrates being transferred from the first device to the second device.

On the one hand the first and second devices are so positioned that their conveying directions are at 90° to one another. On transferring the substrates from the first to the second device there is then automatically a change in the orientation or rotation relative to the conveying direction.

On the other hand, downstream of a first device a rotation station is provided, which takes over the substrates from the first device and transfers the same to the second device, the rotation station rotating the substrates by 90° in the transport plane and transfers the same in this rotated form to the second device. The two devices are then located in a line. According to the invention it is also possible for the rotation angle of the rotation station and the enclosed angle and the transportation directions of the devices to be such that following rotation and transfer to the second device the substrates are turned by 90° thereon.

The rotation station can be constructed for raising and rotating the substrates and for this purpose has rotation devices. Several individual rotation devices can be juxtaposed. It is possible for adjacent rotation devices to be somewhat forwardly or rearwardly displaced in the transportation direction and are in particular alternately arranged on two lines, which are perpendicular to the transportation direction and are spaced, so that there is no substrate interference on rotation. The entire rotation process should take place as rapidly as possible, so that there is a very rapid through transport of the substrates.

According to a third aspect the problem of the invention is solved by a method having the features of claim 12 for wetting a substrate surface with a process medium and involving the following steps: transporting the substrate with transport means in a transport plane, wetting a downwardly directed substrate surface at least substantially located in the transport plane with a process medium, which is applied to the substrate surface with a conveyor in direct, mechanical contact.

Preferably the transportation of the substrate takes place in a substantially linear transportation direction in a transport plane defined by the transport means. To this end the downwardly directed substrate surface is placed on an arrangement of several successive transport means in the transportation direction. The transport means are at least partially coupled to a drive mechanism and are driven by the latter, so that they can bring about a forward substrate movement. Wetting of the downwardly directed substrate surface takes place directly through the transport means in the form of conveyor rollers and which therefore also serve as conveying means for the process medium. Additionally or alternatively wetting can also take place by separate conveying means positioned between the transport means below the transport plane.

According to another development of the invention, a process medium quantity to be applied to the substrate surface by the conveyor roller is set by varying the immersion depth of the conveyor roller in the process medium and/or by varying a conveyor roller rotation speed. A variation of the conveyor roller immersion depth is brought about by varying the filling of the tank with process medium, so that it is possible to set a spacing between the process medium level in the tank and the transport plane. This spacing defines the rotation angle by which the process medium has to be conveyed by the conveyor roller between the liquid level and the substrate surface. With a maximum spacing between the liquid level and transport plane, in which the conveyor roller touches both the transport plane and the liquid level, there is a rotation angle of 180° when the transport plane is horizontally oriented. On reducing the spacing between the liquid level and the transport plane the liquid level acts like a secant to the cylindrical conveyor roller, so that there is a reduction to the rotation angle by which the process medium must be freely conveyed between the liquid level and the substrate surface. When the conveyor roller is immersed by up to one third of the diameter in the process medium, the rotation angle is for example 90°. The smaller to the rotation angle, the larger the process medium quantity reaching the substrate surface for a constant conveyor roller rotation speed.

By varying the rotation speed it is also possible to influence the available process medium quantity. Unlike in the case of the rotation angle, for the rotation speed there is a range differing from zero at which a maximum process medium quantity can be conveyed by the conveyor roller. For lower rotation speeds the process medium flows away from the tank, whereas it is spun away for a higher rotation speed. In a preferred embodiment of the invention a control or regulating device is provided, which as a function of the process medium and the substrates to be treated permits a control or regulation of the rotation speed and/or the immersion depth or liquid level.

In a further development of the invention, through a sucking off of process medium in vapour and/or mist form before and/or during and/or after substrate surface wetting with suction means positioned vertically below the transport plane, it is possible to prevent process medium deposition on other substrate surfaces over and beyond that which is located in the transport plane. Process medium in vapour and/or mist form is sucked off by suction means, which are positioned vertically below the transport plane and bring about a downward vertical air flow in order to prevent process medium deposition on substrate surfaces other than that located in the transport plane.

According to another development of the invention, there is a continuous transportation of substrate and/or a continuous provision of process medium through the conveyor for the wetting of the substrate surface and/or a continuous exhaustion of gaseous or mist-like process medium. Through a continuous transportation of the substrates and/or provision of process medium for wetting the substrate surface and/or exhaustion it is possible to ensure a treatment process in which there is only a minimal and preferably negligible and in particularly preferred manner no deposition of process medium on substrate surfaces which are not to be wetted.

In another development of the invention process medium application to the downwardly directed substrate surface can only take place in the marginal area of the substrates. Such a marginal area can be 5 mm to 15 mm. Advantageously the process medium is applied to the sides of rectangular substrates located to the left and right in the transportation direction and for this purpose use can be made of the previously described conveyor rollers with larger diameter areas on the edge and a smaller diameter area in the centre.

The substrates can firstly be transported with a first orientation or alignment and the edges of the downwardly directed substrate surface can be wetted with process medium. The substrates are then rotated by 90° in the transport plane, followed by further wetting of the edges of the downwardly directed substrate surface on the two other lateral faces. Thus, in each case the marginal areas are wetted and etched.

On the one hand the rotation of the substrates can take place outside the devices with the process medium, for example in the above-described manner at a rotation station between two devices. On the other hand the substrates can be transferred by one device to a further such device, the devices having transportation directions at an angle of 90° to one another and the substrates are transported on the devices with in each case different transportation directions.

These and further features can be gathered from the claims, description and drawings and the individual features, both singly or in the form of subcombinations, can be implemented in an embodiment of the invention and in other fields and can represent advantageous, independently protectable constructions for which protection is claimed here. The subdivision of the application into individual sections and the subheadings in no way restrict the general validity of the statements made thereunder.

### BRIEF DESCRIPTION OF THE DRAWINGS

Embodiments of the invention are described in greater detail hereinafter relative to the attached diagrammatic drawings, wherein show:

FIG. 1 A diagrammatic representation of a device for the surface treatment of substrates in a side view.

FIG. 2 A diagrammatic representation of the device according to FIG. 1 in a part sectional front view.

FIG. 3 A larger scale view of a conveyor roller in the form of a transport roller in the device according to FIGS. 1 and 2.

FIG. 4 A representation illustrating the setting up of the two devices according to FIG. 1 in a single line with a rotation station for the substrates between them.

FIG. 5 A view similar to FIG. 2 of two conveyor rollers according to a second aspect of the invention.

### DETAILED DESCRIPTION OF THE EMBODIMENTS

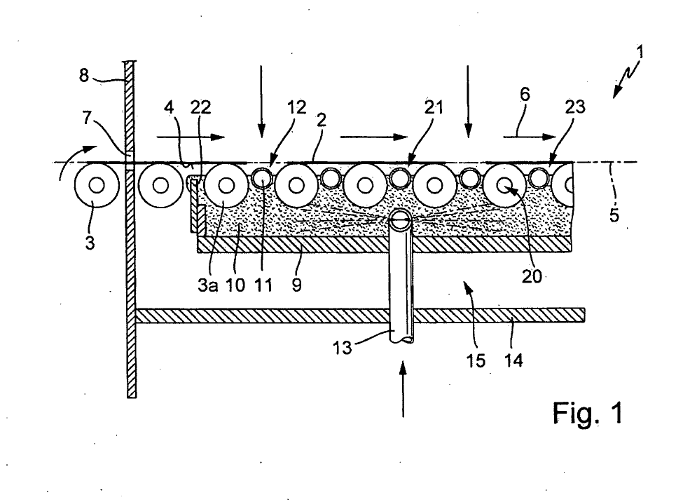

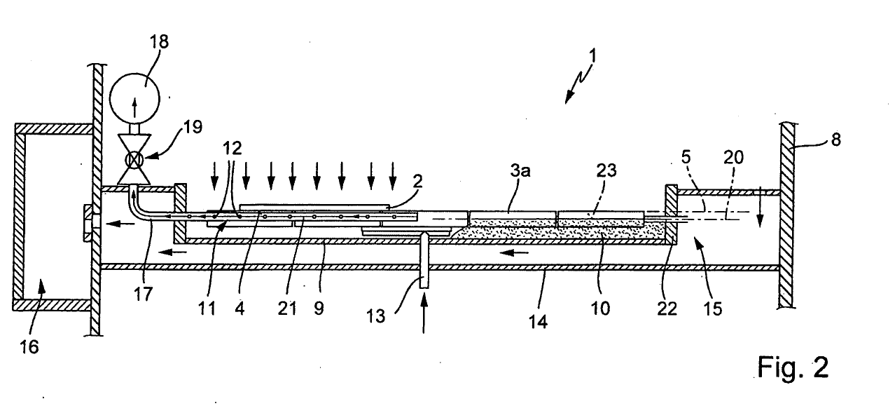

A device 1 for the surface treatment of substrates 2 shown in FIGS. 1 and 2 has several transport means in the form of transport rollers 3, 3a. The transport rollers 3, 3a are intended for a linear transporting of substrates 2 in particular made from a silicon material. The transport rollers 3, 3a define a transport plane 5 oriented in the horizontal direction and which touches at one surface transport rollers 3, 3a. Transport rollers 3, 3a are mounted in rotary manner in device 1 and are driven at least partly by a not shown drive mechanism with a preferably constant, adjustable rotation speed.

Substrate 2 is typically a flat, planar silicon plate or wafer, which has a round contour with a diameter of approximately 60 to 250 mm or a rectangular contour with edge lengths of 60 to 250 mm. The preferred substrate thickness is 0.1 to 2 mm. By means of a downwardly directed substrate surface 4, substrate 2 rests on transport rollers 3, 3a and is moved in a transportation direction 6 by the equidirectional, identical speed rotation of transport rollers 3, 3a.

The function of device 1 can be to remove an in particular electrically conductive coating applied to all sides of substrate 2 on its downwardly directed surface 4 in a wet chemical process using a liquid process medium without damaging the coating applied to the remaining substrate surfaces.

For this purpose substrate 2 with substrate surface 4 is placed on transport rollers 3, 3a and moved through an intake port 7 into an almost completely closed process chamber 8 which is only intimated in the drawings. The process chamber 8 contains a tank 9 completely filled with a liquid process medium 10, particularly with aqueous solutions of hydrofluoric acid (HF(aq)) and/or hydrochloric acid (HCl(aq)) and/or nitric acid (HNO₃(aq)) and/or potassium hydroxide (NaOH(aq)). Tank 9 is spaced from a bottom 14 of process chamber 8, so that between the tank 9 and bottom 14 a suction shaft 15 is formed ensuring suction on the marginal area of tank 9. As shown in greater detail in FIG. 2, the suction shaft 15 extends beneath the entire tank 9 and consequently permits a sucking off of process medium 10 in vapour and/or gas form and which passes out over the edge of tank 9 and which has not been subject to the action of suction means 11. The suction shaft 15 is coupled to a spent air shaft 16 fitted laterally to the device 1 and which is subject to a vacuum action. A medium line 13 supplies fresh process medium to tank 9.

To ensure wetting of the downwardly directed substrate surface 4, the transport rollers 3a fulfil a double function, i.e. they not only serve as the transport means for substrate 2, but also as a conveyor for process medium 10. For conveying process medium 10 from tank 9 into transport plane 5, the transport rollers 3a are fitted in tank 9 in such a way that they are partially immersed in process medium 10 and a liquid level 23 is above the rotation axis 20 of the cylindrical conveyor rollers 3a. The transport rollers in the form of conveyor rollers 3a have a wettable surface, so that they can convey the process medium 10 upwards and with a limited coating thickness counter to the force of gravity into transport plane 5 and in a rolling process, i.e. in a direct, mechanical contact, can bring about a transfer to substrate surfaces 4. As the process medium only rests with a limited coating thickness on transport rollers 3a, even in the case of a limited thickness of substrates 2 it is ensured that the process medium 10 does not reach an upwardly directed substrate surface.

To ensure that the upwardly directed substrate surface remains free from process medium 10, suction means 11 are provided for the suction or exhaustion of process medium in gas and/or mist form and which can be present in the area around the transport rollers 3a acting as conveying means. The process medium 10 has a vapour pressure, so that as a function of the surrounding atmospheric conditions, such as for example the ambient temperature and air pressure, the process medium 10 evaporates to a greater or lesser extent and mixes with the ambient air. In addition, as a result of the relative movement between transport rollers 3a and process medium 10 and rolling processes of the conveyor means 3a on the substrate surface 4, there can also be a detachment of very small process medium droplets present as finely dispersed mist above the liquid level of process medium 10. Admittedly a mixture of gas and/or vapour form process medium 10 with the ambient air is typically heavier than the latter, but as a result of the relative movements of conveyor means 3a and substrates 2 there is a whirling up of the ambient air and which, without suction means 11, can bring about a rise of the process medium in gas and/or mist form above transport plane 5.

As a result the process medium 10 in gas and/or mist form can be deposited on the upwardly directed surface of substrate 2. As this is undesired, suction means 11 are provided and are fitted as vacuum-supplied pipes between the transport rollers 3a and in each case have several suction openings 12 through which the gas and/or mist form process medium 10 can be sucked off in an area below transport plane 5 and can consequently not pass beyond said plane 5 onto the upwardly directed substrate surface. Therefore the suction means 11 are arranged vertically below the transport plane 5 and bring about a substantially vertically directed air flow, which is preferably in low turbulence and more especially laminar form.

By means of a drainage pipe 18, the suction means 11 are connected to a suction line 18, which is supplied with a vacuum by a not shown pumping device. For the individual setting of suction means 11, between the drainage pipe 17 and suction line 18 a setting valve 19 is provided and is constructed as a throttle valve and makes it possible to influence a volume flow exhausted by suction line 18.

For a particularly compact arrangement of suction means 11 in device 1, a median longitudinal axis 21 of the tubular suction means 11 is oriented parallel to a rotation axis 20 of transport rollers 3a and suction means 11 is placed in a gap defined by transport rollers 3a and transport surface 5, as well as in the downwards direction by the liquid level of process medium 10. Thus, despite a limited spacing of transport rollers 3, it is possible to have a large cross-section for suction means 11. Thus, even in the case of high volume flows sucked through suction means 11, a low flow rate can be ensured in suction means 11. In addition, there is also a large outer surface of suction means 11 in which can be made a large number of suction openings 12, so that there is a low turbulence and in particular laminar air flow in the vertical downwards direction, so as to ensure a reliable suction of gaseous or mist-like distributed process medium 10.

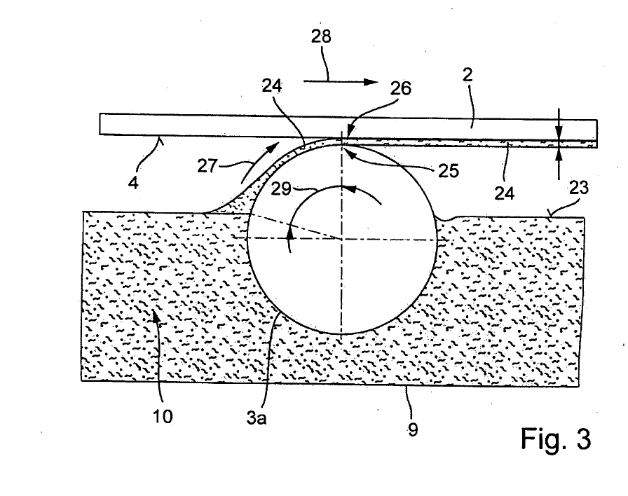

According to FIG. 3, which is a diagrammatic detail enlargement of the conveyor rollers 3a constructed as transport rollers shown in FIGS. 1 and 2, process medium 10 is conveyed from tank 9 over and beyond liquid level 23 as a result of the rotation of transport roller 3a in the direction of the downwardly directed substrate surface 4 and in direct mechanical contact wets with process medium 10 substrate surface 4. Conveyor roller 3a partially immersed in process medium 10 is completely surrounded by the latter in an immersed portion and is consequently wetted. Through the rotation of conveyor roller 3a a thin process medium film 24 can be entrained by conveyor roller 3a in rotation direction 27. Through the design of the outer surface of conveyor roller 3a and in particular through a suitable material choice and an optionally provided structuring, i.e. by pores, grooves or depressions, a thickness of the process medium film 24 can be defined which can be entrained when the conveyor roller portion passes out of the process medium 10 and which is at least partially transferred to substrate surface 4. The thickness of process medium film 24 is also dependent on the immersion depth in the process medium 10 and a free rotation angle 29 defined by the same and the rotation speed of conveyor roller 3a, which also determines the transportation speed of substrate 2 in transportation direction 28. At a linear contact point extending in the drawing plane the process medium 10 is transferred to the downwardly directed substrate surface 4 and at the contact point 26 as a result of the weight of substrate 2 and the characteristics of substrate surface 4 and process medium 10, particularly the wettability of substrate surface 4 and the surface tension of process medium 10, there is an at least almost completely liquid-filled capillary gap 25, which is responsible for a uniform distribution of process medium 10 on substrate surface 4. Due to the direct mechanical transfer of process medium 10 to substrate surface 4, it is possible to ensure an advantageous, low-mist and low-vapour wetting of substrate surface 4, which ensures a selective surface treatment of substrate 2.

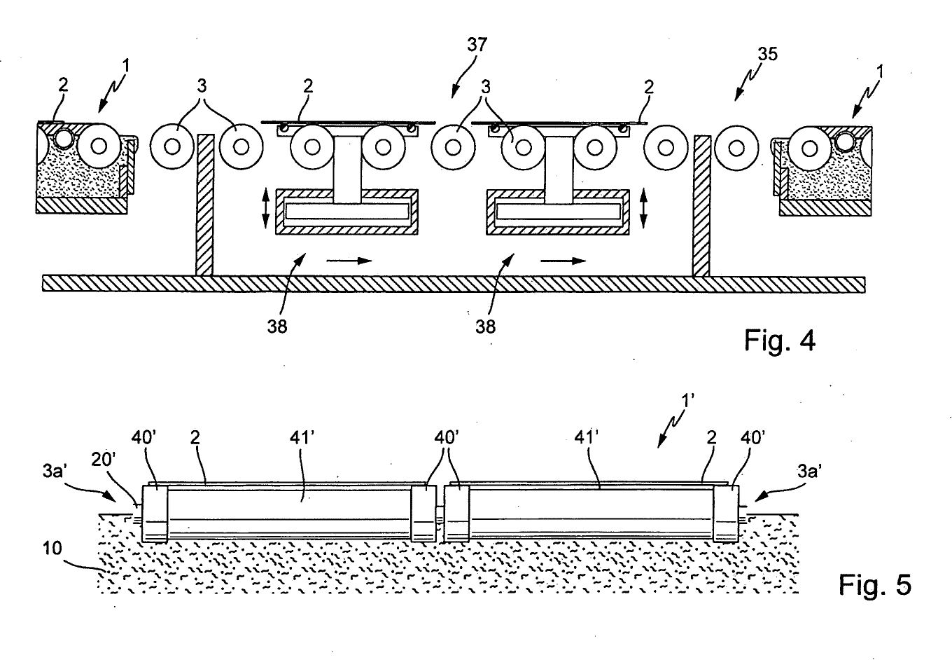

FIG. 4 shows the structure of a system 35 with two devices 1 according to FIG. 1. Devices 1 are in a line and have a significant mutual spacing, a rotation station 37 being formed between them. The transportation path for the substrates 2 between the two devices 1 has further transport rollers 3, which transport on the substrates 2 at the same height and in the same direction. Rotation station 37 has several rotation devices 38, which are constructed for raising the substrates. The substrates are raised from transport rollers 3, rotated by 90° and then deposited again on transport rollers 3 for further transportation from the left-hand device 1 to the right-hand device 1. Raising advantageously takes place with air pressure and simultaneously the substrates 2 can be firmly sucked by their undersides onto the rotation devices 38. Such rotation devices are known per se, both with respect to the raising and with respect to the rotation, so that no further explanations are needed here. It is pointed out regarding rotation station 37 that the rotation devices 38 are so positioned transversely to the left to right transportation direction, that several substrates 2 transported in juxtaposed paths can in each case be rotated by a rotation device 38. To ensure that substrates 2 or rotation stations 38 do not lead to mutual interference, the adjacent rotation stations are in each case forwardly and rearwardly mutually displaced.

FIG. 5 shows an alternative construction of a device 1′ similar to that of FIG. 2 and on a larger scale. On a rotation axis 20 rotation takes place of conveyor rollers 3a′ and they are immersed roughly half in the process medium 10. At the ends the conveyor rollers 3a′ have thickened marginal areas 40′ with somewhat thinner central areas 41′ between them. With respect to the marginal areas 40′, conveyor rollers 3a′ are so constructed that in each case the substrates 2 rest on the marginal area 40′ and are substantially free in the central area. Thus, not completely planar substrates 2, which are slightly uneven or corrugated for example due to the manufacturing or working process, are wetted with process medium 10 accompanied by a permanent, good engagement on conveyor rollers 3a′ or marginal areas 40′. As described hereinbefore, precisely at the outer areas or edges of the substrates maximum importance is attached to the etching and therefore also the wetting with process medium 10. If the substrates 2 were bent downwards in the centre, at least in one marginal area there would be no contact with the conveyor roller and consequently no etching process at this point. This is in fact brought about by the so-to-speak wasp-waisted conveyor rollers 3a′ or their thinner central areas 41′.

Whilst with regards to their liquid absorption capacity or transportation capacity for the liquid 10, the construction of the central areas 41′ is unimportant, the marginal areas 40′ are advantageously constructed as described hereinbefore with regards to the complete conveyor roller 3a and to this extent reference is made thereto. The thickness or diameter difference between the marginal areas 40′ and central areas 41′ can be a few mm and can for example be 2 to 10% of the diameter.

As it is clear from FIG. 5 that the substrates 2 are only etched in the lateral outer areas in the transportation direction and the front and rear outer areas are unetched, there is no need for this to take place. The arrangement according to FIG. 4 with system 35 is very useful for this purpose, because there in the left-hand device 1 one pair of facing, lateral outer areas or edges is etched. Through rotation station 37 with rotation devices 38 substrates 2 are rotated by 90° in the transport plane and set down again. The transport rollers 3 transport them to the right-hand device 1 and there again the two remaining outer areas are etched. Obviously the construction according to FIG. 5 with the thinner conveyor rollers 3a′ in a central area 41′ can be used with advantage not only in the case of curved or domed substrates 2, but also with planar substrates. The individual case decides how the best results can be obtained.

In a further development it is possible for the marginal areas 40′ not to be fixed to conveyor rollers 3a′ and can instead be displaced, so that there is an overlap of for example 10 mm between substrate 2 and marginal area 40′ with the support. Thus, with marginal areas 40′ constructed like rings or the like and displaceable on conveyor rollers 3a′ along rotation axis 20′, different substrates 2 can be treated or there can be an adaptation of the inventive system 1′ to different substrate widths.

1. Device for the surface treatment of substrate, with transport means for transporting a substrate in a transport plane defined by transport means and with at least one conveying means, which is constructed for a wetting of substrate with a liquid process medium, wherein the conveying means is positioned below transport plane in such a way that it touches or at least extends close to transport plane for wetting the downwardly directed substrate surface with process medium in direct contact between conveying means and substrate surface, wherein said conveying means is constructed as a conveyor roller positioned in such a way that it touches the transport plane, wherein the conveyor rollers have a varying diameter with at least two larger diameter areas projecting over at least one smaller diameter area.

2. Device according to claim 1, wherein said two larger diameter areas are in each case provided on the end sides of said conveyor rollers.

3. Device according to claim 1, wherein with said conveyor rollers is associated a supply device for supplying said process medium to an outer surface of said conveyor rollers.

4. Device according to claim 1, wherein said conveying means has a porous outer surface, which is constructed for transporting said process medium from at least one delivery point provided in said conveyor rollers to an outer surface of said conveyor rollers.

5. Device according to claim 1, wherein said conveyor roller is provided with holes or grooves having a depth in the range 0.1 mm to 1 mm.

6. Device according to claim 1, wherein said larger diameter areas project approximately 1 to 10 mm over an at least one smaller diameter area.

7. Device according to claim 1, wherein said larger diameter areas are at least 10 mm wide.

8. Device according to claim 1, wherein said larger diameter areas are constructed according to the features of claim 5, wherein at least one smaller diameter area has a smooth surface.

9. System with at least two devices according to claim 1, wherein a first device with a first transportation direction is provided and is followed by a second device with a second transportation direction, said substrates passing from the first device to the second device, said first transportation direction being rotated by 90° relative to said second transportation direction.

10. System with at least two devices according to claim 1, wherein downstream of a device is provided a rotation station, which takes over said substrates from said first device and transfers them to second device, said substrates being turned by 90° in said transport plane on said second device when compared with said first device.

11. System according to claim 10, wherein said rotation station rotates said substrates, it being provided with rotation devices for raising and rotating said substrates.

12. Method for wetting a substrate surface of a substrate with a process medium involving the steps:
of transporting said substrate with transport means in the form of conveyor rollers in a transport plane,
of wetting a downwardly directed substrate surface at least substantially located in said transport plane with a process medium, which is applied with said conveyor roller in direct mechanical contact to the substrate surface, wherein said application of process medium to said downwardly directed surface of said substrate takes place in a marginal side area of said substrates.

13. Method according to claim 12, wherein a quantity of said process medium, which can be applied by said conveyor roller to said substrate surface, is set by varying a rotation speed of said conveyor roller in said process medium.

14. Method according to claim 12, wherein there is provided a suction of said process medium in gas form before, during or after wetting said substrate surface with suction means arranged vertically below said transport plane in order to prevent a deposition of said process medium on said substrate surfaces other than said substrate surface located in said transport plane.

15. Method according to claim 12, characterized in that said process medium is applied to said sides of said substrates located to the left and right in said transportation direction using conveyor rollers according to claim 1.

16. Method according to claim 12, wherein said substrates are firstly transported with a first orientation or alignment and said marginal sides of said downwardly directed substrate surfaces are wetted with said process medium, followed by a rotation of said substrates by 90° in said transport plane, wherein then a further wetting of said other two remaining lateral faces of said downwardly directed substrate surfaces takes place.

17. Method according to claim 16, wherein said rotation of said substrates takes place outside said device according to claim 1 at a rotation station between two said devices.
